(19) United States
(12) Patent Application Publication
(10) Pub. No.: US 2019/0147677 A1
(43) Pub. Date: May 16, 2019

(54) Remote Lock for Leashes and Collars

(71) Applicant: Laura Faye Rutledge, Calhoun, GA (US)

(72) Inventor: Laura Faye Rutledge, Calhoun, GA (US)

(21) Appl. No.: 15/811,672

(22) Filed: Nov. 15, 2017

(51) Int. Cl. G07C 9/00

(52) U.S. Cl. CPC G07C 9/00309; G07C 2009/00769; G07C 9/00896

(57) ABSTRACT

A remote control universal pet restraining lock system that provides temporary restraint and includes a remote key fob or transmitting unit which may be carried by the pet owner or user. This fob may transmit coded function signals directing the main lock unit to perform requested functions, e.g. unlock the pet, flash the LED, release the Collar Clip-on Pin unit, and an on-board receiver in the main lock unit that receives the request and performs the function. The receiver will send a return signal to the remote and display an appropriate LED colored light and beep acknowledgement to the owner user that the lock has been unlocked and that the Collar Clip-on Pin Unit has been released from the main lock control unit which drops away allowing the pet to roam free.

### FIELD OF THE INVENTION

This is a device that fits universal animal leashes and collars that relates to the field of pet safety and convenience to the owner and a multipurpose remote controlled temporary restraining locking device.

### BACKGROUND OF THE INVENTION

There are no mechanisms or devices that give the ability to temporarily restrain your pet providing hand-free movement to the owner and remotely release the pet from a distance, is mobile and easy-to-use, and user friendly. Various products are out to keep the dog inside a particular boundary, but none offer the ability to restrain a pet or animal for the user and then release the animal remotely, from a distance. For one example, temporarily securing a pet inside the garage as one backs the car out. Then, the user releasing the animal remotely from the user's vehicle, after the garage door is closed allowing the pet to roam freely inside the garage.

Most leashes and products require permanent attachment to a holding position or require the owner to tie up one hand holding the pet. No leashes allow release of the animal from a distance.

What is needed is a convenient, safe way to maintain control over the dog, hands-free and subsequently releasing the dog into its pen or stored area from a remote location.

We are a pet loving world. Most pets are considered a valued member of their family. For a small investment, pets give so much love and are a joy and comfort when one needs good companionship. Pets, especially puppies and kittens, provide hours of entertainment and humor for both young and old pet owners. Pets teach valuable lessons in responsibility and unconditional love and devotion. In return, many pet owners are taking optimal care of their pets and providing them with good veterinary care, food, toys and sleeping beds. In addition to attending to their pet's health and comfort needs, pet owners attend to their pet's safety and security in urban and suburban locales during the commute of the pet owner's commute away from the pet's dwelling. With over 70 million dog owners in the U.S. alone, this temporary Leash Lock restraint system will make life easier and provide a helping hand to animal and pet owners while improving on safety, security, and protection of pets and animals.

### SUMMARY OF THE INVENTION

In accordance with this invention, methods and systems are provided for the lock to attach to most universal leash and collars by this locking unit that enables a user to have a method to temporarily secure their pets to any stationary post, using standard pet leash and collar products or other material with strength enough to hold, allowing wireless unlock activation, without requiring contact or line of sight access between lock and user with remote. Remote control range unlock activation can be provided by pressing the remote control unlock button from a few feet up to varying distances depending on which type wireless technology that is included and the number of walls or rooms that the signal is traveling. Wireless technologies will include 433 MHZ RF, Bluetooth, Cellular and GPS. The user need only carry the universal remote control key FOB somewhere on their person in order to unlock their locked pets or other locked items and uses as owners may see fit.

In accordance with future embodiments, wireless communication protocols such as Bluetooth, Cellular, and GPS, etc. will be integrated into the system to allow the owner user to select the option that best suits their application.

In accordance with an embodiment of the 433 MHZ RF, a handheld remote control unit carried by the user transmits wirelessly (e.g., an RF signal) a unique code to a receiver circuit board coupled inside a mechanism comprising a lock housing, battery, motor, and mechanics to lock and release a collar clip-on hook and pin section of the lock. The lock to be activated by the hand held remote control unit which is equipped with a receiver control board which receives the code sent by the remote control unit (transmitter). When the code transmitted by the remote matches a corresponding code in the receiver inside the main lock housing unit, the receiver recognizes the code and activates a releasing mechanism and releases the universal collar clip-on pin unit away from the main lock housing unit.

In one embodiment, the remote transmitter can be associated with more than 1 lock and can be programmed to be recognized by a number of locks, thereby allowing owner/user to open many locks at one time.

This invention will be more fully understood in conjunction with the following detailed description taken together with the drawing.

### BRIEF DESCRIPTION OF THE DRAWINGS

In order that the advantages of certain embodiments of the invention will be readily understood, a more particular description of the invention briefly described above will be illustrated in the appended drawings. While it should be understood that these drawings depict only typical embodiments of the invention and are not therefore to be considered to be limiting of its scope. The invention will be described and explained with additional specificity and detail through the use of the accompanying drawings, in which:

FIG. 1 is a perspective view illustrating the combination of the Main Lock Control Leash Attach Unit and the Universal Clip-on Pin Unit in the closed locked position. This comprises the complete locking unit of the Remote leash lock restraint system for pet and animal leash and collar, according to an embodiment of the present invention.

FIG. 2 is a perspective view of the Universal clip-on pin unit that clips onto pet collars.

FIG. 3 is a perspective view of the main leash lock unit that attaches to universal pet leashes.

FIG. 4 is a perspective view of the complete system exploded to expose all parts of the Remote leash lock restraint system for pet and animal leashes and collars.

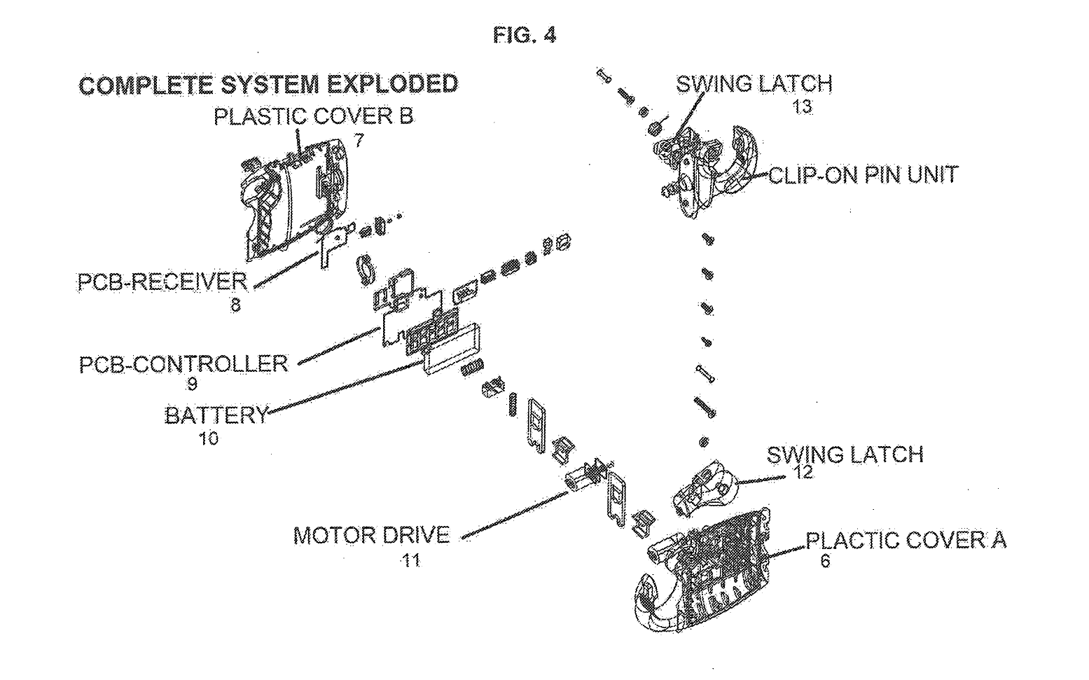

FIG. 5 is a flow chart of the remote control open and unlock process of the system.

FIG. 6 is a perspective view of the present embodiment of a handheld remote control unit only and not intended to be limited to design or pattern.

### DETAILED DESCRIPTION OF THE PRESENT EMBODIMENT

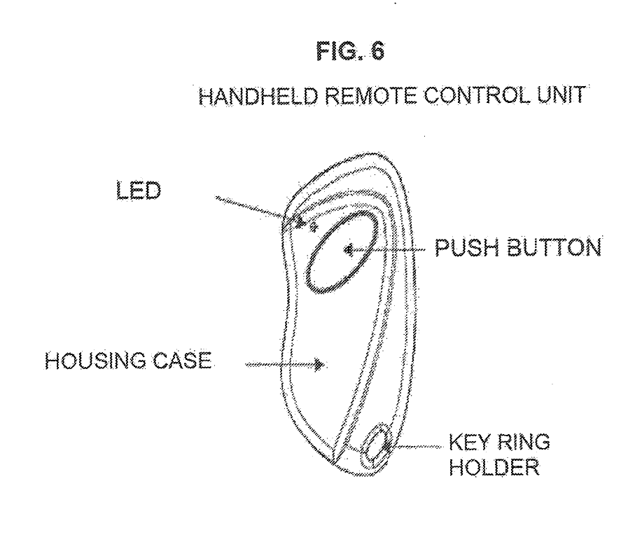

This description is illustrative of the embodiment of the present invention only and not intended to be limiting. For example, in this detailed description, a handheld remote control unit FIG. 6 is described which includes a radio frequency 433 MHZ (RF) signal transmitter for transmitting a unique ID code to the signal receiver located in the main lock control unit 1. The present invention is not limited, however, by the form of wireless signal transmission or any particular communication protocol between the transmitter and the receiver of the ID code. Wireless communication protocols like Bluetooth, Cellular, and GPS, along with newer wireless communications that may become available and may be used in present and future embodiments.

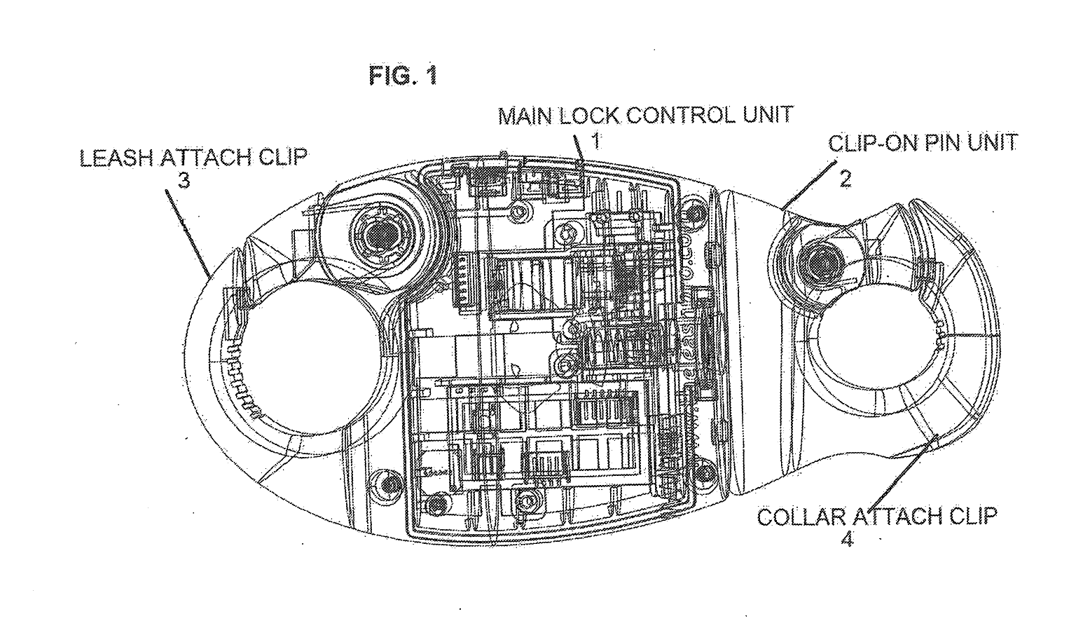

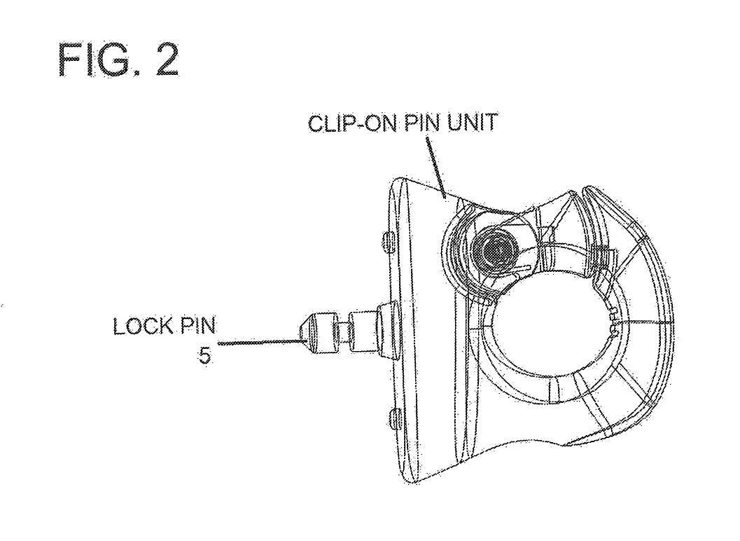

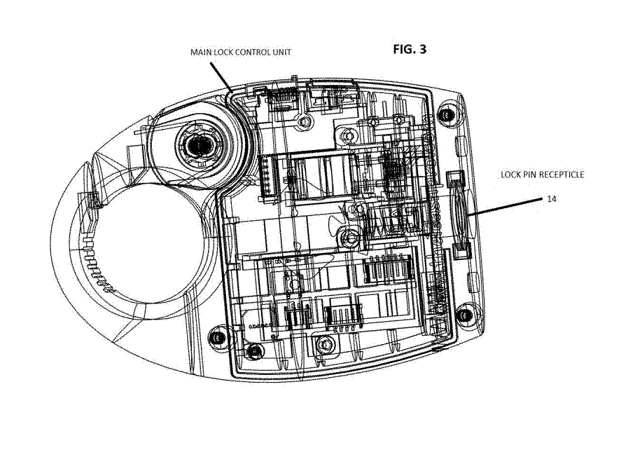

FIG. 1 represents a perspective view illustrating the combination of the main control leash attach unit 1 and the universal collar clip-on unit 2 in the locked position. This comprises the leash lock restraint system according to an embodiment of the present invention. This system can be used typically for dogs. However, the system may be used for any other suitable animal in some embodiments, such as cats. The Universal collar clip-on pin unit, FIG. 2, can be clipped on to the ring of present universal collars. Most conventional collars have a metal ring that is at the center of the collar for accessibility to clip a standard leash snap hook. The Universal collar clip-on unit, FIG. 2, can be detached from the Main Control Unit pin receptacle 14 and attached to this metal ring of the pet collar. The main lock unit, FIG. 3, assembles together with the collar clip-on pin unit, FIG. 2, by inserting the lock pin 5 of the pin unit into the pin receptacle 14 of The Main Control Unit, FIG. 3. When the owner is ready to secure or temporarily restrain the animal, the user may attach the handle of the lead line or leash to any suitable immovable object (such as a stable post, railing, fence, or item) to the Leash attach clip 3. A suitable & immovable object can be anything with enough stability to temporarily hold the animal in its' safe environment. The safe environment would include any area that may be normal for the pet such as a garage, fenced in area, training range, inside a home, area, space or the like. However, the owner/user may use any suitably durable material such as rubber, nylon, leather, etc., with adequate strength for this application in order to attach to an object, securing the animal. An adjustable sliding leash/lead line may be used to offer various sizes of adjustments to secure to larger stable objects, such as a tree or larger immovable objects as such.

When the owner/user is ready to restrain the animal they can simply bring the Pin Unit, FIG. 2, and the Control Unit, FIG. 3, together and insert the Pin unit into the Control unit locking pin receptacle 14 until the Pin is locked into position.

Then the owner may release the animal from restraint at a distance or another remote location by pressing the open button on the handheld remote control unit (FIG. 6). The distance of release is determined by the signal strength of the wireless communications technology (433 MHZ, Bluetooth, GPS, or cellular) being used in the remote control unit and the Main Lock Control Unit.

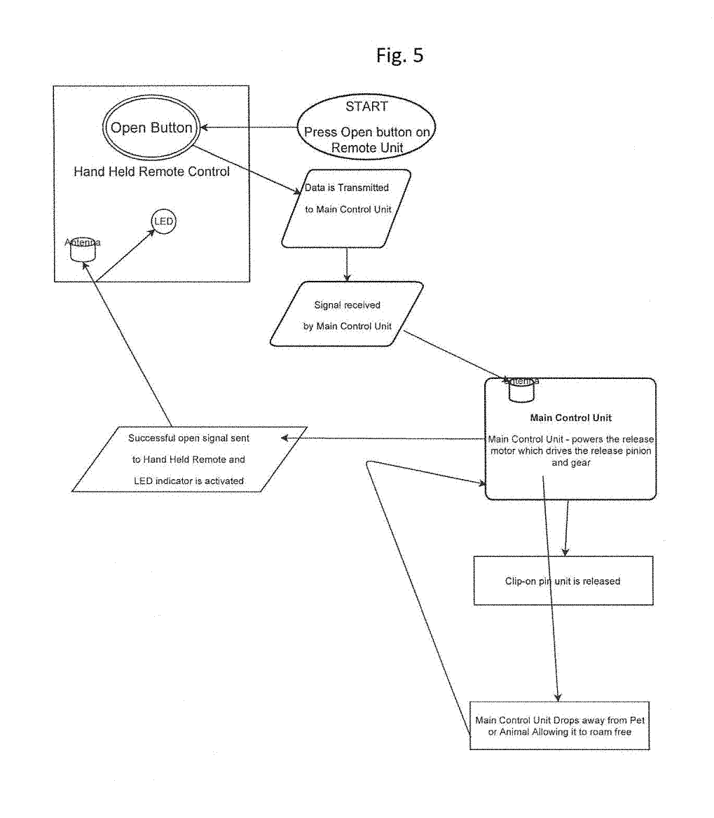

FIG. 5 Represents the Unlock/Release Process. When the owner/user presses the button on the handheld remote control unit, the unit sends a signal to the receiver in the Main Control Unit 8 and activates a rechargeable battery 10 with drive motor 11 that is attached to a movement that will retract the pin hold arm thereby releasing the Collar Clip-on Pin Unit FIG. 3 from the Main Lock Control Unit FIG. 2. Then the Main Lock Control Unit, along with its tethered leash, will fall away from the animal and allow it to roam free in its' protected area, training range, or such other enclosed area that the owner user may desire; without having to go to the animal and release it by hand.

1. A Temporary Restraining Universal Leash Locking System that fits universal leashes and collars and provides temporary restraint for a pet/animal to an immovable object, or to secure any object, and gives the convenience to release the animal or object remotely from a distance, comprising:
a Handheld Mobile Device, said handheld mobile device comprising:
a transceiver, configured to transmit and receive wireless signals activated by a user to and from a Main Lock Control Device; and
an enclosure, said enclosure including:
first and second opposing distal end portions; and
a main housing portion being interposed between said first and second opposing distal end portions;
wherein the first opposing distal end portion includes a selectively opened pivot hinge for attachment to a further object; and the second opposing distal end portion includes a universal collar clip-on device with dual attachment functions,
wherein one side of said universal collar clip-on device is configured to
selectively attach to the ring of a universal pet collar; and the other side is configured to include a male connector that has a locking insert for locking into a main lock control device;
the main housing portion enclosing a main lock control device, said main lock control device being configured to respond to wireless signals from the handheld mobile device; and
wherein the main lock control device comprises:
a wireless signal transceiver for receiving and transmitting wireless signals to and from a handheld mobile device; and
a female connector with mechanical components that lock and release said universal collar clip-on device.

2. The Temporary Restraining Universal Leash Locking System of claim 1, wherein the Main Lock Control Device is adapted to receive the wireless signals from the Handheld Mobile Device from varying distances or other remote locations.

3. The Temporary Restraining Universal Leash Locking System of claim 1, wherein the Main Lock Control Device has an activation distance according to the wireless technology used (400 MHZ range, Bluetooth, Cellular, GPS).

4. The Temporary Restraining Universal Leash Locking System of claim 1, wherein the Main Lock Control Device comprises mechanical components that accept, lock, and hold the Universal Collar Clip-on Device, mechanical components being actuated by a latch drive, driven by a battery powered controller and motor.

5. The Temporary Restraining Universal Leash Locking System of claim 1, wherein the Handheld Mobile Device further comprises a battery and an indicator for indicating successful release of the Main Lock Control Device from the Universal Collar Clip-on Device.

6. The Temporary Restraining Universal Leash Locking System of claim 1, wherein the wireless communications comprises a wireless technologies compliant with versions of 400 MHZ range, Bluetooth, Cellular, or GPS.

7. The Temporary Restraining Universal Leash Locking System of claim 1, wherein the Main Lock Control Device comprises a status light, battery charge indicator, and charging port.

8. The Temporary Restraining Universal Leash Locking System of claim 1, wherein the Main Lock Control Device comprises a water-resistance so as to prevent water or other substances from entering and harming internal components.

9. The Temporary Restraining Universal Leash Locking System of claim 1, wherein the Handheld Remote Control Device is configured to provide an audible or visible indication that the Main Lock Control Device has unlocked and released the Universal Collar Clip-on Device.

10. The Temporary Restraining Universal Leash Locking System of claim 1, wherein the Main Lock Control Device and the Universal Collar Clip-on Device fits onto connecting points of collars, leashes, and other means of attachment.
